(19) United States
(12) Patent Application Publication
(10) Pub. No.: US 2026/0245537 A1
(43) Pub. Date: Aug. 20, 2026

(54) SILENCER BOX

(71) Applicant: SAMUEL CHEN, Causeway Bay (HK)

(72) Inventor: SAMUEL CHEN, Causeway Bay (HK)

(21) Appl. No.: 19/265,811

(22) Filed: Jul. 10, 2025

Related U.S. Application Data
(63) Continuation-in-part of application No. 29/989,998, filed on Feb. 18, 2025.

(51) Int. Cl. G10K 11/178; B65D 81/18; G10K 11/168

(52) U.S. Cl. CPC G10K 11/17861; G10K 11/168; B65D 81/18

(57) ABSTRACT

A silencer box for housing a sound-emitting device includes multi-layered construction with an outer durable shell and an inner acoustic layer. The enclosure supports airflow through dedicated inlet and outlet channels while reducing noise. A lid provides access and may include a storage pocket. A carry handle facilitates transport. Optionally, internal microphones, speakers, and a noise cancellation circuit produce anti-noise waveforms for active attenuation. The enclosure serves both consumer and industrial purposes as a portable silencing system for motors, fans, and pumps.

### FIELD OF THE INVENTION

The present invention relates generally to sound attenuation and noise reduction systems. More specifically, it pertains to a portable, multi-layered silencer box designed to accommodate a variety of sound-generating devices such as blowers, air pumps, or inflation modules, integrating both passive and active noise mitigation technologies.

### DISCUSSION OF RELATED ART

Many mechanical and electrical devices generate undesirable noise during normal operation. Portable blowers, air compressors, electric motors, and pumps are essential in both residential and industrial environments. However, the operational noise levels from such devices can be intrusive or harmful.

Efforts to mitigate such noise have typically fallen into two categories: built-in device modifications or fixed environmental installations. Neither offers a flexible, universally adaptable, and mobile solution. Notable prior art includes: A variety of different silencer boxes have been discussed in United States patents. For example, in U.S. Pat. No. 8,337,145 entitled, “Quiet Blower Apparatus and System and Method for Reducing Blower Noise,” by Robert H. Frater, Hamish A. Urquhart, Dmitri A. Doudkine, and Barton J. Kenyon, published Dec. 25, 2012, the inventors describe, “A blower assembly including a motor, an impeller and a volute that is configured such that an inlet chamber of the volute and an outlet chamber of the volute are divided from one another by an airtight membrane and the membrane is configured to allow the transmission of pressure waves between the inlet and outlet chambers.”

For example, in U.S. Pat. No. 10,473,046 entitled, “Engine System for Working Machine Configured to Contain Noise Reduction Equipment,” by Masataka Mitsuda, published Nov. 12, 2019, the inventor describes, “An engine system for a working machine includes an engine disposed in a main body of the working machine, an exhaust manifold coupled to the engine, a tail pipe, an exhaust—gas purification device disposed in the main body and including an exhaust—gas inlet—side housing. The exhaust—gas inlet—side housing includes an exhaust—gas inlet coupled to the exhaust manifold, and an exhaust—gas outlet—side housing including an exhaust—gas outlet coupled to the tail pipe. The exhaust gas purification device is configured to purify exhaust gas discharged from the engine and to cause the purified exhaust gas to be discharged from the tail pipe to an outside of the engine system. The engine system is configured such that a silencer housing is disposable in the exhaust—gas inlet—side housing, the exhaust—gas outlet—side housing, or both, to attenuate exhaust sound of the engine.”

For example, in U.S. Pat. No. 11,610,573 entitled, “Noise Cancellation Using Segmented, Frequency-Dependent Phase Cancellation,” by Eugene Seagriff and Jean-Claude Junqua, published Mar. 21, 2023, the inventors describe, “Noise abatement within a signal stream containing unwanted signal referred to as noise is performed by acquiring a digitized noise signal and using a digital processor circuit to subdivide the acquired noise signal into different frequency band segments and thereby generate a plurality of segmented noise signals. Then individually for each segmented noise signal, the processor shifts in time the segmented noise signal by an amount dependent on a selected frequency of the segmented noise signals to produce a plurality of shifted segmented noise signals. The precise time shift applied to teach noise segment considers the frequency content of the segment and the system processing time. Individually for each segmented noise signal, amplitude scaling is applied. The shifted and amplitude-scaled segmented noise signals are then combined to form a composite anti-noise signal which is output into the signal stream to abate the noise through destructive interference.”

For example, in U.S. Pat. No. 7,938,618 entitled, “Device For Silencing a Helicopter Gas Turbine Engine and Engine Thus Obtained” by Pierre Michel Baude, published May 10, 2011, the inventor describes, “In a helicopter gas turbine engine, lips defining a radial air intake are connected along an opening of an engine compressor air supply passage. The air intake lips are at least partially formed by a sound attenuator calculated to attenuate sound frequencies produced by the compressor rotation.”

For example, in U.S. Pat. No. 7,942,234 entitled “Noise suppressor, electronic apparatus, and noise suppression characteristic control method” by Motoyasu Utsunomiya, published May 17, 2011, the inventor describes, “A noise suppressor for an apparatus having a cooling fan and cooling duct includes a muffler including a reflection plate for reflecting sound from the cooling fan, the reflection plate being provided at a position in the cooling duct confronting the intake plane of the cooling fan and formed substantially parallel to the intake plane. A sound-absorbing part of the muffler is provided on the reflection plate, and a distance d between the reflection plate and the intake plane is set such that d<c/(2×f) where f is the sound-absorption frequency of the muffler and c is the speed of sound.”

For example, in U.S. Pat. No. 10,670,048 entitled “Blower with improved sound reduction”, by Göran Landén, Tobias Nyberg, Fredrik Wibling, and Christian Bylund published Jun. 2, 2020, the inventors describe, “A blower (100) may include a housing (110), a motor (120), a fan assembly (170) and an inlet assembly (160). The housing (110) may include a handle (140) operably coupled thereto. The fan assembly (170) may be operably coupled to the motor (120) to force air through a blower tube (150) responsive to operation of the motor (120). The blower tube (150) may define a tube axis (152). The inlet assembly (160) may provide a path for air to the fan assembly (170). The inlet assembly (160) may include an inlet aperture (162) formed at an end of the housing (110). The inlet assembly (160) may further include an inlet mesh (164) disposed within the housing (110) spaced apart from the inlet aperture (162).”

### SUMMARY OF THE INVENTION

The silencer device muffles a sound generator and doubles as a container. The container includes a handle and base. The silencer covers the sound generator and attenuates sound. The invention described herein provides a novel silencer enclosure that addresses the above needs. The enclosure comprises a body and lid, constructed from an outer fabric or polymeric structural layer and an interior acoustic foam or similar sound-dampening layer. The enclosure defines a cavity to receive a sound-emitting device and includes ports for air ingress and egress. The system optionally integrates an active noise cancellation (ANC) circuit, including microphones to detect sound signatures and speakers to generate anti-noise waveforms. A hinged and zippered lid provides access. A carry handle is affixed for portability. The design mimics travel luggage in function while delivering technical noise reduction performance. The invention further includes methods for using such an enclosure to reduce emitted noise by housing a device, sealing the structure, and enabling passive and optionally active acoustic attenuation.

The present invention provides a sound-dampening enclosure designed to substantially reduce the audible noise from a sound-generating device placed within it. The enclosure is configured as a portable, soft-sided container, similar in construction to luggage, making it easy to transport and store. In one aspect, the invention is an enclosure comprising a body and a lid, which together define an internal cavity for housing a sound-generating device, such as an inflation module. The body and lid are constructed from a flexible outer layer and an inner sound-dampening layer. The enclosure includes an inlet opening to allow air intake for the device and an outlet opening for exhaust. In another aspect, the enclosure features a carry handle attached to its top panel, enhancing its portability. The lid may be attached to the body by a hinge and secured by a zipper closure, allowing for easy access to the internal cavity. In a further aspect, the invention incorporates an active noise cancellation system. This system includes a first microphone positioned to detect noise from the sound-generating device, an active noise cancellation circuit to generate an anti-noise signal, and a first speaker to output the anti-noise signal, thereby destructively interfering with the original noise. The system may also include a second microphone and second speaker near the enclosure's openings to further cancel noise escaping the enclosure. The invention also provides a method for dampening sound from a device. The method comprises placing the device inside the cavity of the described silencer box, closing the lid, and operating the device, wherein the enclosure absorbs and cancels noise generated by the device.

The silencer box is composed of multiple interconnected panels: a rear panel, front panel, left panel, right panel, top panel, and bottom panel. Together, these form an enclosure that defines an internal cavity to house a device such as a fan motor or inflation module. Each panel has at least two layers: an outer structural layer, which may be woven fabric or polymer-reinforced canvas, and an inner sound-absorbing layer, such as closed-cell acoustic foam. Additional sound panels line the inner cavity, including a lid panel as well as front, right, left, rear, and bottom panels.

A lid is joined to the enclosure body via a hinge and sealed with a zipper closure system that has an upper and lower interface. The lid includes its own outer layer and may contain a utility pocket for accessories such as cables, remote controllers, or battery packs for the active noise cancellation system.

Air is admitted to the interior through an inlet opening, which can be covered with an air intake grille, and it exits through an outlet. These airflow paths permit the internal device to function without significant performance loss while minimizing sound leakage. The carry handle is mounted to the top panel using an attachment base with front and rear connections, a loop, and reinforced stitching. The mounting is suitable for field transport, mimicking luggage handles for user comfort. Panel corners are joined using edge seams and connection elements, reinforcing the corners.

In some embodiments, the enclosure includes active noise control components. Microphones are located near the device and its inlet and exhaust ports. These feed into an active noise cancellation circuit, which generates an anti-noise signal that is played through speakers. This signal destructively interferes with the ambient sound, attenuating the output across relevant frequency bands. A series of figures show orthogonal external views, including the placement of the intake grille and the orientation of the outlet.

### BRIEF DESCRIPTION OF THE DRAWINGS

FIG. 1 is a rear perspective view of an embodiment of the silencer box.

FIG. 2 is a front perspective view of the embodiment of FIG. 1.

FIG. 3 is a detailed view of the carry handle attachment on the top panel of the enclosure.

FIG. 4 is a detailed view of the panel connections at a corner of the enclosure.

FIG. 5 is a top perspective view showing the carry handle assembly.

FIG. 6 is a side view of an alternative embodiment of the enclosure, showing a soft-sided construction with a zipper closure.

FIG. 7 is a top-down view of the enclosure with the lid open, showing the arrangement of internal sound panels and the fan module cavity.

FIG. 8 is a detailed view of the lid, showing the hinge and an internal pocket.

FIG. 9 is a top-down view of the enclosure with the lid open, showing the placement of an inflation module and active noise cancellation components within the fan module cavity.

FIG. 10 is a front perspective view of an embodiment of the enclosure.

FIG. 11 is a bottom perspective view of the enclosure.

FIG. 12 is a front elevational view of the enclosure.

FIG. 13 is a rear elevational view of the enclosure.

FIG. 14 is a right side elevational view of the enclosure.

FIG. 15 is a left side elevational view of the enclosure.

FIG. 16 is a top plan view of the enclosure.

FIG. 17 is a bottom plan view of the enclosure showing an air intake grille.

FIG. 18 is a circuit block diagram of the present invention.

The following call out list of elements can be a useful reference for referring to the FIG.
30 inflation module
34 fan motor
35 air inlet conduit
36 air inlet collector
45 carry handle
46 air intake grille
100 sound cover
101 sound cover rear panel
102 sound cover left panel
103 sound cover right panel
104 sound cover left panel
105 sound cover top panel
106 sound cover bottom panel
107 exhaust cover
108 exhaust cover tab
109 exhaust cover hinge
110 carry handle attachment
111 carry handle first stitch line
112 carry handle second stitch line
113 carry handle strap mount
114 carry handle rear connection
115 carry handle loop
116 carry handle front connection
120 panel connection
121 front upper edge
122 upper right edge
123 front right edge
125 front left edge
126 upper right front corner
130 outer layer
131 sound layer
132 lid
133 zipper closure
134 zipper upper interface
135 zipper lower interface
136 hinge
137 lid outer layer
138 body
139 body outer layer
140 sound panel
141 lid sound panel
142 front sound panel
143 right sound panel
144 left sound panel
145 rear sound panel
146 bottom sound panel
147 outlet opening
148 inlet opening
149 fan module cavity
150 lid pocket
201 first microphone
202 first speaker
203 second microphone
204 second speaker
205 active noise cancellation circuit

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

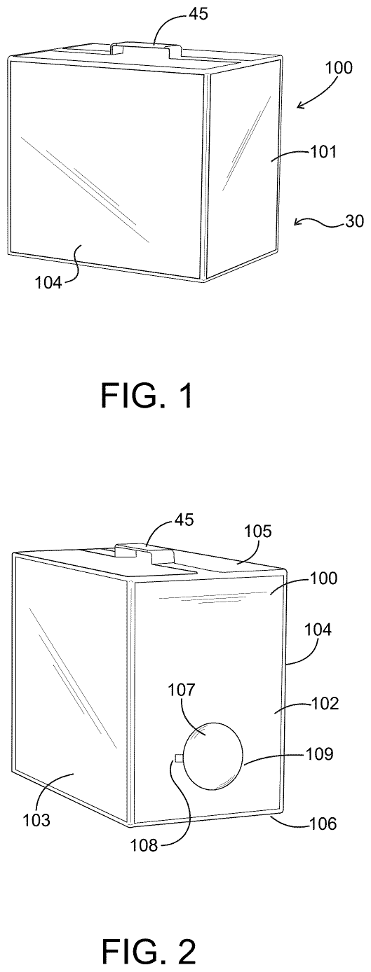

As seen in FIG. 1 and FIG. 2 illustrate an embodiment of the silencer box, referred to as a sound cover 100. The sound cover 100 is designed to enclose a sound-generating device, such as an inflation module 30, to attenuate its operational noise. The sound cover 100 is constructed as a box-like structure with a sound cover rear panel 101, a sound cover front panel 102, a sound cover right panel 103, a sound cover left panel 104, a sound cover top panel 105, and a sound cover bottom panel 106. A carry handle 45 is attached to the sound cover top panel 105 to facilitate transportation. The front panel 102 may include an exhaust cover 107, which can be opened and closed via a tab 108 and is attached by a hinge 109. FIG. 1 and FIG. 2 show the sound-dampening enclosure 100 as a rectangular, box-like housing formed from a set of interconnected panels. These include the rear panel 101, front panel 102, right panel 103, left panel 104, top panel 105, and bottom panel 106. The panels are joined along their edges using panel connections 120 (see also FIG. 4), forming a sealed cavity. A carry handle 45 is mounted on the top panel 105 for portability. An exhaust cover 107 is positioned on the front panel 102 and includes a tab 108 and hinge 109 for opening and closing to regulate air exhaust. The enclosure is designed to surround a sound-generating device such as an inflation module 30, which is inserted into the cavity and operated while the lid is sealed. The panel structure includes a flexible outer layer 130 and a sound-dampening inner layer 131, offering both mechanical protection and acoustic insulation.

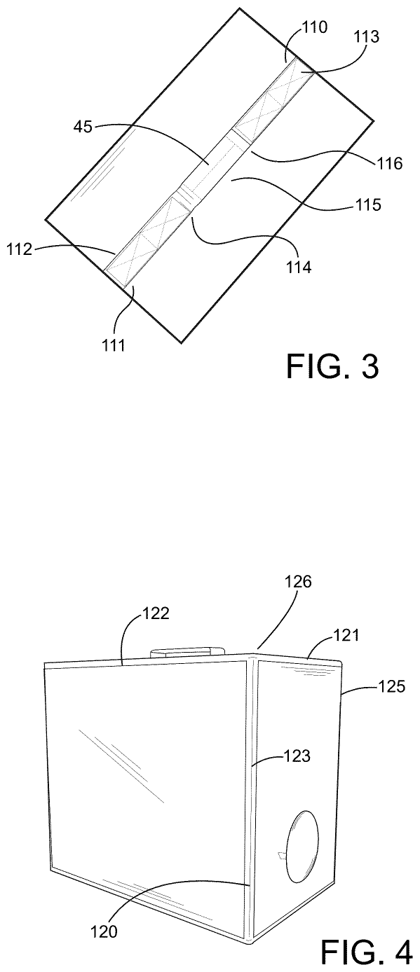

FIG. 3 shows the carry handle attachment system 110 in greater detail. The handle 45 is formed as a loop 115 and is secured to the enclosure top panel 105 using a rear connection 114 and a front connection 116. Stitch lines 111 and 112 reinforce the carry handle strap mount 113. This design mimics a luggage-style carry handle, enhancing user comfort during transport and allowing repositioning of the enclosure while in use. As shown in FIG. 3, the carry handle 45 is part of a carry handle attachment 110 that is secured to the sound cover top panel 105. The attachment may be a strap mount 113 that is stitched to the top panel 105 with a first stitch line 111 and a second stitch line 112. The carry handle 45 itself can be a loop 115 formed between a carry handle rear connection 114 and a carry handle front connection 116, providing a robust and comfortable grip.

As shown in FIG. 4, the panels are joined at reinforced corners, such as the front upper edge 121, upper right edge 122, front right edge 123, front left edge 125, and upper right front corner 126. These edges are joined using high-strength stitching or bonding to maintain the structural integrity of the enclosure under repeated use. FIG. 4 shows a typical panel connection 120 at an upper right front corner 126. The sound cover top panel 105 forms a front upper edge 121 and an upper right edge 122. The sound cover right panel 103 and front panel 102 meet at a front right edge 123. The sound cover left panel 104 and front panel 102 meet at a front left edge 125. These panels can be stitched or otherwise joined to form the box-like structure.

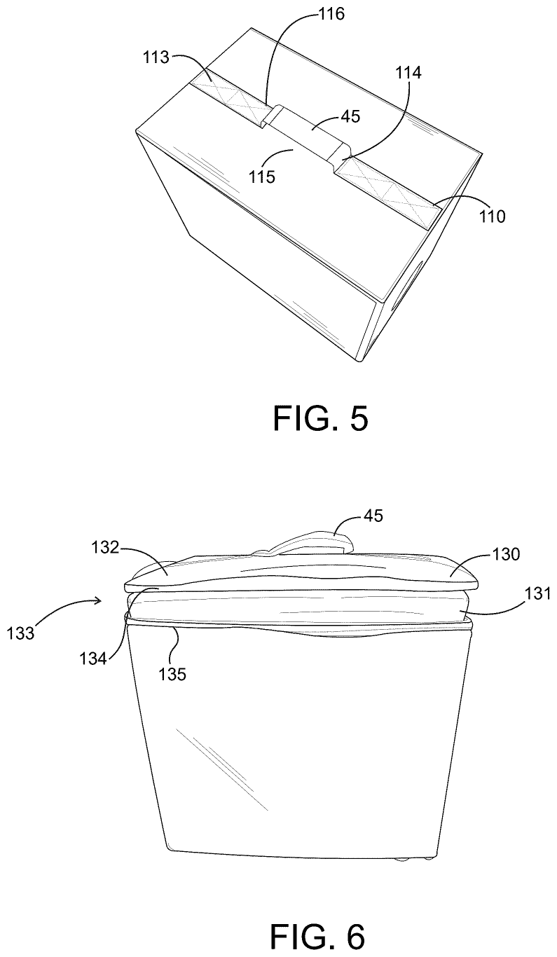

FIG. 5 provides another view of the carry handle assembly, highlighting the loop 115 between the front and rear handle connections (116 and 114). This design allows the enclosure to be lifted comfortably with one hand, and the flat profile of the loop allows the enclosure to sit flush in compact storage.

FIG. 6 illustrates an alternative embodiment with a soft-sided, luggage-style construction. The enclosure comprises a body 138 and a lid 132. The lid 132 and body 138 are both constructed with an outer layer 130 and an inner sound layer 131. The lid 132 is secured to the body 138 via a zipper closure 133, which has a zipper upper interface 134 on the lid and a zipper lower interface 135 on the body. A carry handle 45 is attached to the lid 132.

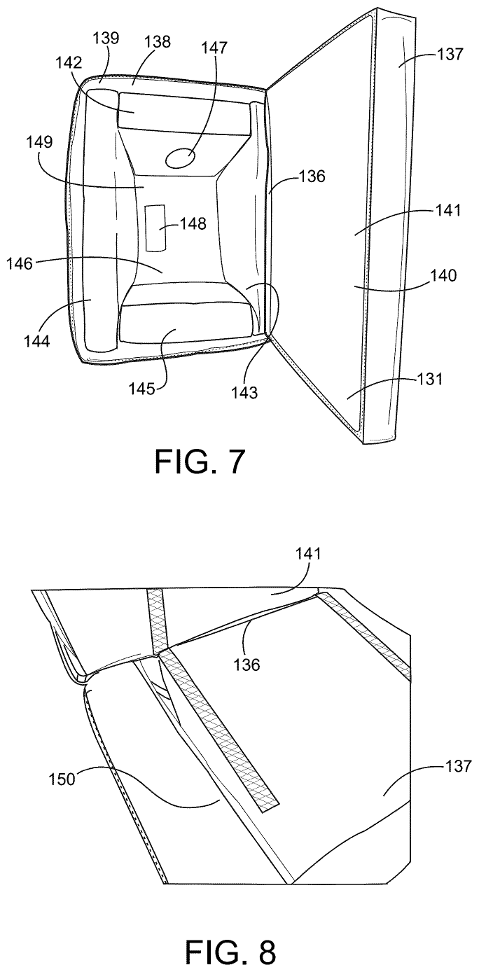

With the lid 132 open (hinged at 136), FIG. 7 illustrates the arrangement of internal sound-dampening panels. The internal walls are lined with modular sound panels: lid panel 141, front panel 142, right panel 143, left panel 144, rear panel 145, and bottom panel 146. These panels may be detachable or replaceable, allowing for maintenance or material changes to target specific frequencies. The interior cavity 149, called the fan module cavity, houses the sound-generating device. An inlet opening 148 allows air intake, while the outlet opening 147 allows exhaust airflow. FIG. 7 shows the interior of the enclosure with the lid 132 open, attached by a hinge 136. The interior is lined with a plurality of sound panels 140. These include a lid sound panel 141, a front sound panel 142, a right sound panel 143, a left sound panel 144, a rear sound panel 145, and a bottom sound panel 146. These panels form the sound layer 131 and are made of a sound-absorbing or sound-blocking material. The body 138, which has an outer layer 139, defines a fan module cavity 149 for receiving the sound-generating device. An inlet opening 148 allows air to enter the cavity, and an outlet opening 147 in the lid allows air to exit.

FIG. 8 highlights the interior construction of the lid 132. A lid pocket 150 is built into the lid's outer layer 137 and can be used to store accessories such as remote controls, cables, or an active noise cancellation (ANC) battery pack. The lid includes the same sound-dampening layering as the body, enhancing noise attenuation when sealed. As shown in FIG. 8, the lid 132 may also include a lid pocket 150 for storing accessories.

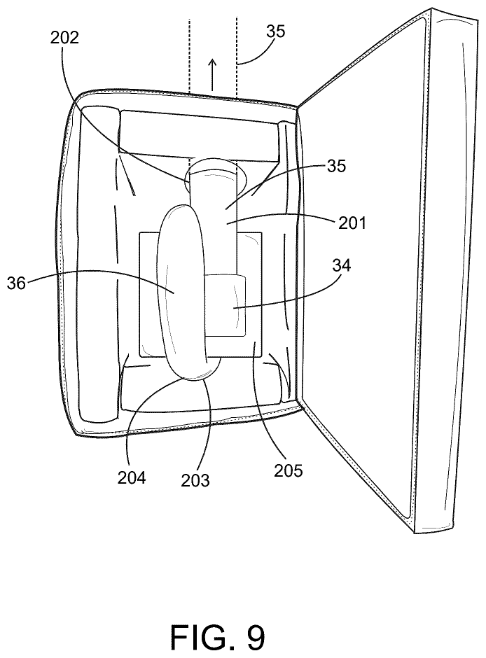

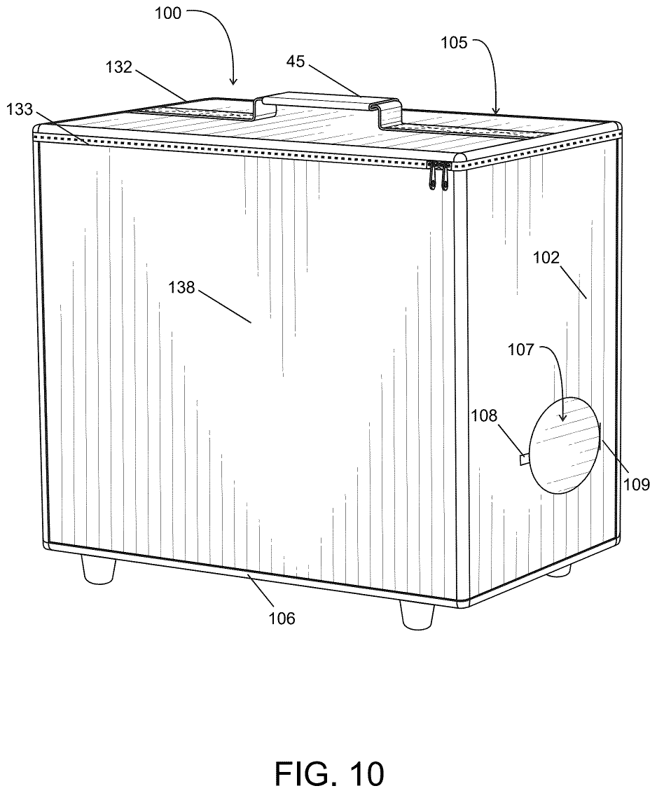

FIG. 9 shows an open-top view of the enclosure with the inflation module installed and illustrates the placement of an inflation module within the fan module cavity 149. This configuration maintains device airflow while minimizing sound leakage. The inflation module includes a fan motor 34. An air inlet conduit 35 directs air from an air inlet collector 36 to the fan motor 34. This embodiment also includes an active noise cancellation system. A first microphone 201 is positioned near the fan motor 34 to detect noise. The signal is sent to an active noise cancellation circuit 205, which generates an anti-noise signal. A first speaker 202, also positioned within the cavity, emits the anti-noise signal to cancel the fan noise. A second microphone 203 and second speaker 204 may be positioned near an opening of the enclosure to cancel any residual noise that may escape. The microphone detects the operational noise, and the circuit 205 generates an anti-noise signal emitted by the speaker 202. Additional microphones (203) and speakers (204) are placed near the openings to cancel residual noise escaping through the air channels. This system enables attenuation of broadband noise between 500 Hz and 8000 Hz using destructive interference.

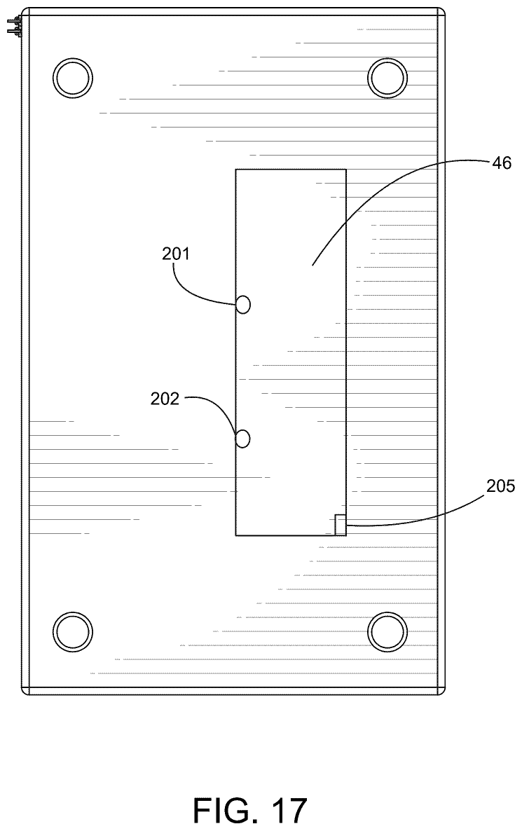

FIGS. 10-17 show various external views of an assembled embodiment. FIG. 17 shows a bottom view with an air intake grille 46, which corresponds to the inlet opening 148. The active noise cancellation components, such as the first microphone 201, first speaker 202, and circuit 205, can be integrated near this grille.

FIG. 10 presents an assembled front-perspective view of the silencer box 100. The lid 132 is shown zipped to the body 138 along zipper closure 133, and the carry handle 45 rises from the center of the top panel 105. From this angle the exhaust cover 107 on the front panel 102—as well as its tab 108 and hinge 109—are visible, illustrating how exhaust airflow is managed while the enclosure remains fully portable. This view shows the clean, box-like form factor, the prominent carry handle 45 on top, and the zipper closure 133 running along the upper perimeter, securing the lid to the body. Feet on the bottom panel 106 are visible, which serve to elevate the enclosure slightly from the ground, protecting the bottom surface and aiding in stability.

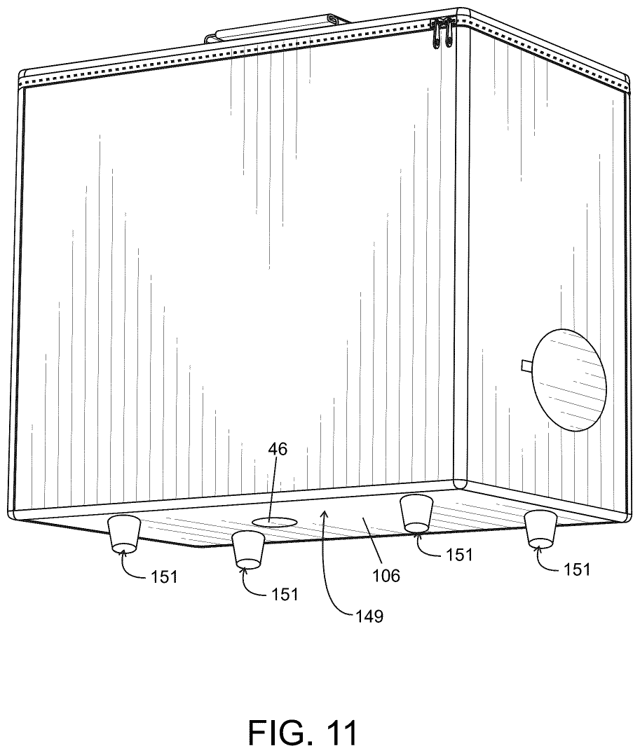

FIG. 11 looks upward toward the underside of the enclosure. The bottom panel 106 carries an air-intake grille 46 positioned centrally below the fan module cavity 149. Four optional non-slip feet 151 elevate the enclosure slightly to keep the grille clear of the floor and to reduce vibration transfer. The figure highlights the continuous seam lines that seal the lower edges of the side panels and prevent sound leakage. This view further clarifies the placement of the feet at the corners of the bottom panel 106. This elevation can also help prevent the obstruction of the air intake grille located on the bottom surface.

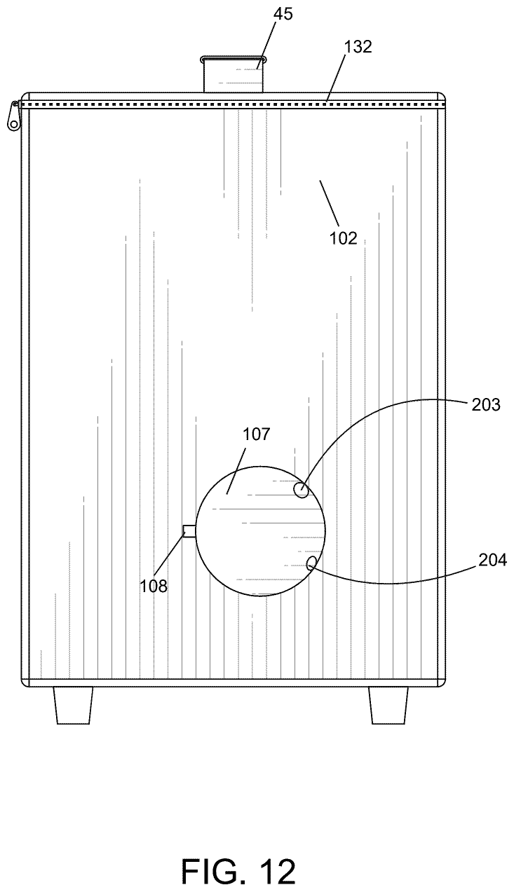

FIG. 12 is an orthographic front view that defines the enclosure's overall height and width. The exhaust cover 107 occupies the upper region of the front panel 102, and its tab 108 projects slightly to facilitate manual opening. The carry handle 45 appears above the lid 132, demonstrating its centered placement and reinforcing that the load path is aligned with the enclosure's center of gravity. In this embodiment, the second microphone 203 and second speaker 204 of the active noise cancellation system are shown integrated into or adjacent to this exhaust port to address residual noise as it exits the enclosure.

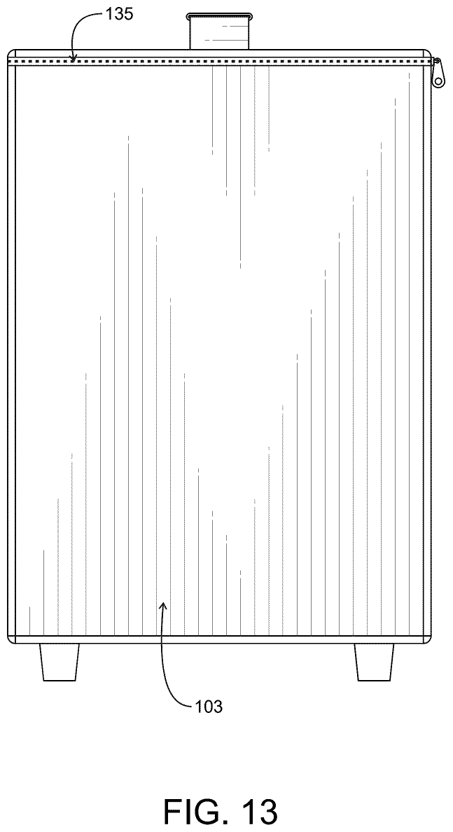

FIG. 13 shows the rear panel 101 in elevation. The view is largely featureless, emphasizing the sealed construction. The upper edge of the rear panel reveals the lid hinge 136, while the stitch lines attaching the rear panel to the adjacent side panels are visible, ensuring that the acoustic barrier is continuous around the enclosure. This continuous surface, free of openings, maximizes the passive sound-blocking capability of the enclosure's rear wall.

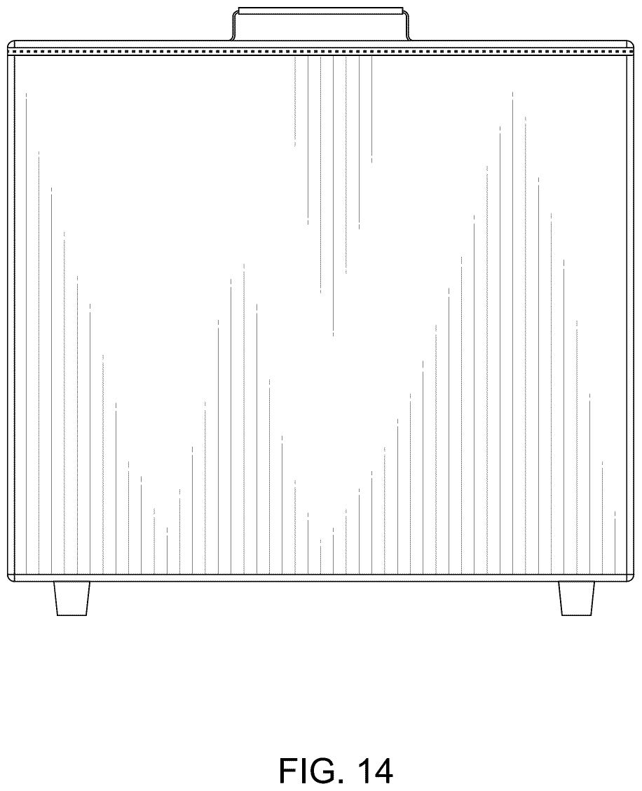

FIG. 14 provides a right-side profile of the enclosure. The right panel 103 is bounded by zipper lower interface 135 and by the upper and lower seam edges. This view also shows the slight lid overhang created by the zipper chain, illustrating how the lid nests over the body to maintain an acoustic seal when closed. Like the rear view, this solid, continuous panel contributes to the overall structural and acoustic integrity of the enclosure.

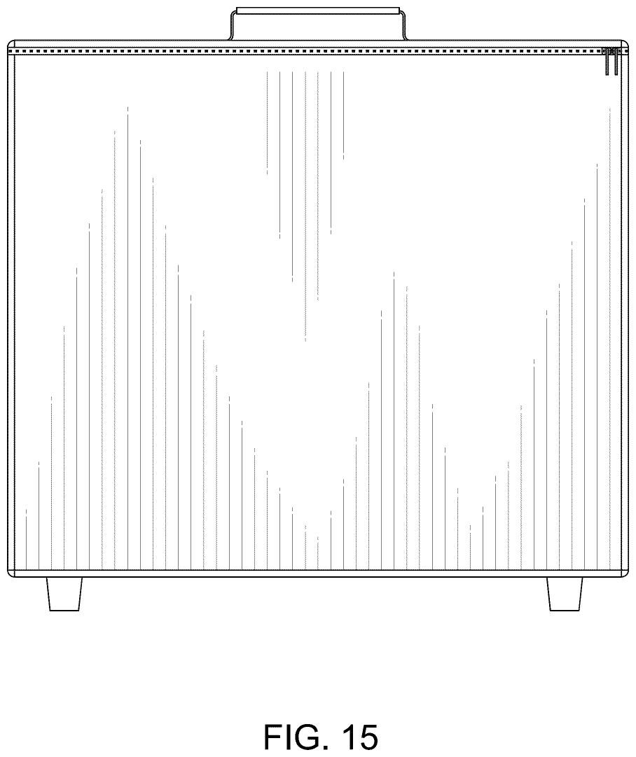

FIG. 15 is a left-side profile that mirrors FIG. 14. In some embodiments this panel may incorporate a cable pass-through grommet (not shown) for powering the inflation module or the ANC electronics while preserving the enclosure's sound integrity. Stitching and panel-edge reinforcements are identical to those on the right side, underscoring construction symmetry. Like the right panel, the left panel provides an uninterrupted structure to support both the physical strength and acoustic containment of the system.

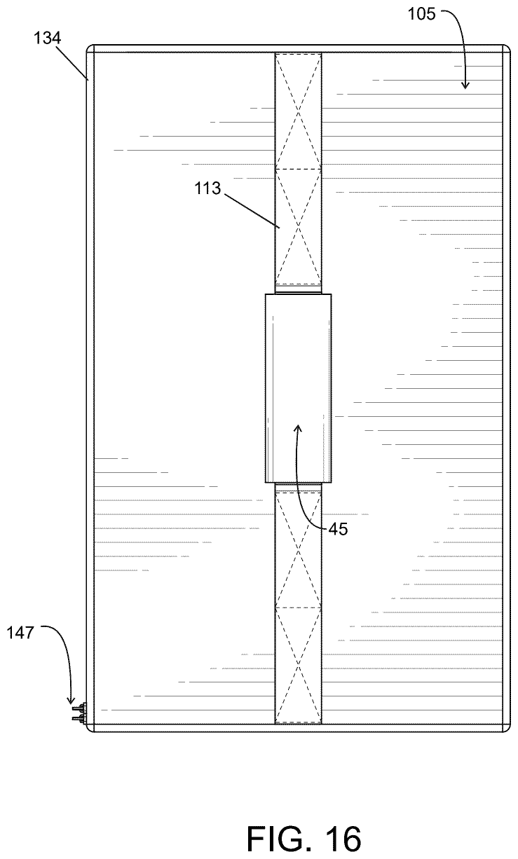

FIG. 16 depicts the enclosure viewed from above with the lid closed. The carry handle 45 sits centrally on the top panel 105, and the zipper upper interface 134 traces the lid's perimeter, indicating the path along which the user unzips the enclosure. The outlet opening 147 is visible near the rear edge of the lid. This view also provides a clear look at the carry handle 45 and its attachment strap mount 113 as they are centered on the sound cover top panel 105. This symmetrical placement ensures the enclosure is balanced when carried.

FIG. 17 is a plan view of the underside of the enclosure. The air-intake grille 46 dominates the center of the bottom panel 146 and aligns vertically with the inflation module's inlet conduit 35. Dashed outlines indicate the internal positions of the first microphone 201 and first speaker 202 used for active noise cancellation, as well as the routing of cabling toward the power amplifier 214. The optional non-slip feet 151 are shown at the corners, framing the grille and denoting the enclosure's footprint. This grille allows for necessary airflow to the device inside while preventing debris from entering. The components of the primary active noise cancellation system, namely the first microphone 201, first speaker 202, and the active noise cancellation circuit 205, are shown integrated within the perimeter of this intake area, allowing them to target the noise at its source and as it enters the airflow path.

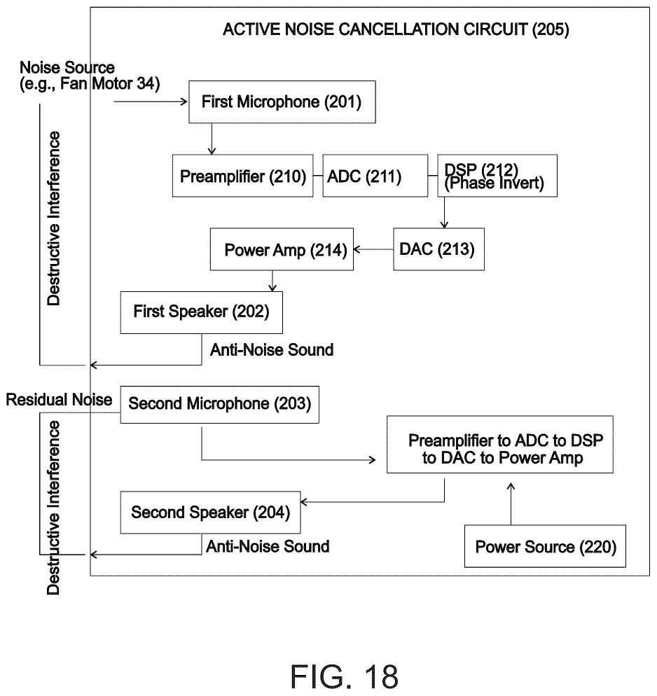

Turning now to FIG. 18, a functional block diagram illustrates the operation of the active noise cancellation circuit 205. The circuit is designed to operate in two stages: a primary internal cancellation stage and a secondary residual cancellation stage. The primary stage begins with the Noise Source (e.g., Fan Motor 34) generating unwanted sound waves within the enclosure. The First Microphone (201), positioned near the noise source, captures this sound and converts it into an analog electrical signal. This signal is sent to a first processing channel within the circuit 205. Inside the circuit, the signal is first amplified by a Preamplifier (210) and then converted into a digital signal by an Analog-to-Digital Converter (ADC) (211). The core of the circuit is the Digital Signal Processor (DSP) (212), which executes an algorithm to invert the phase of the digital signal, creating an anti-noise signal. This digital anti-noise signal is then converted back to an analog signal by a Digital-to-Analog Converter (DAC) (213) and amplified by a Power Amplifier (214). Finally, the amplified anti-noise signal is fed to the First Speaker (202), which emits sound waves that are 180 degrees out of phase with the original noise, causing destructive interference and cancellation. The secondary stage operates identically to address Residual Noise that may escape the enclosure, using the Second Microphone (203), a second parallel processing channel in the circuit 205, and the Second Speaker (204). The entire circuit is powered by a Power Source (220), such as a battery or an external power adapter.

1. A sound-dampening apparatus for a sound-generating device, comprising: a body having a plurality of body panels defining a cavity for receiving the sound-generating device, said body having an inlet opening for providing airflow to the sound-generating device; a lid coupled to said body, said lid configured to enclose the cavity, said lid having an outlet opening; wherein said body and said lid are each constructed of a flexible outer layer and a sound-dampening inner layer; and a carry handle attached to the apparatus.

2. The apparatus of claim 1, wherein said lid is coupled to said body by a hinge.

3. The apparatus of claim 1, further comprising a zipper closure configured to secure said lid to said body.

4. The apparatus of claim 1, wherein said sound-dampening inner layer comprises a plurality of sound panels, including a front sound panel, a rear sound panel, a right sound panel, a left sound panel, and a bottom sound panel.

5. The apparatus of claim 1, wherein said carry handle is attached to a top panel of said lid.

6. The apparatus of claim 1, further comprising an active noise cancellation system, said system comprising: a first microphone positioned within said cavity to detect a noise signal from the sound-generating device; an active noise cancellation circuit electrically coupled to said first microphone, said circuit configured to generate an anti-noise signal based on said noise signal; and a first speaker positioned within said cavity and electrically coupled to said circuit, said first speaker configured to emit said anti-noise signal.

7. The apparatus of claim 6, wherein the active noise cancellation system further comprises: a second microphone positioned proximate to one of said inlet opening or said outlet opening; and a second speaker positioned proximate to one of said inlet opening or said outlet opening, said second speaker configured to emit a second anti-noise signal.

8. The apparatus of claim 1, further comprising an air intake grille covering said inlet opening.

9. The apparatus of claim 1, wherein said flexible outer layer is made of a woven fabric material.

10. A silencer box, comprising: a flexible, soft-sided body defining an interior cavity shaped to receive a portable inflation module, the body comprising a base panel, a front panel, a rear panel, and two side panels; a flexible, soft-sided lid hingedly attached to the body, the lid configured to cover the interior cavity; a zipper for securing the lid to the body; wherein the body and the lid are each comprised of an exterior fabric layer and an interior sound-absorbing layer; a carry handle affixed to an exterior surface of the enclosure; an air inlet on the body; and an air outlet on the lid.

11. The enclosure of claim 10, further comprising an active noise cancellation system having a microphone, a speaker, and a control circuit, wherein the microphone and speaker are disposed within the interior cavity.

12. The enclosure of claim 10, wherein the interior sound-absorbing layer is comprised of a plurality of discrete sound panels attached to an interior surface of the exterior fabric layer.

13. The enclosure of claim 10, wherein the lid further comprises an interior pocket.

14. A method for dampening sound from a portable air pump, the method comprising: providing a silencer box having a body defining a cavity, a lid, a carry handle, an inlet, and an outlet, wherein the enclosure is constructed from a flexible outer layer and a sound-dampening inner layer; placing the portable air pump into the cavity of the body; closing the lid to enclose the portable air pump within the enclosure; and operating the portable air pump, wherein air is drawn through the inlet and exhausted through the outlet, and wherein noise generated by the portable air pump is attenuated by the sound-dampening inner layer.

15. The method of claim 14, further comprising the step of activating an active noise cancellation system within the enclosure to generate an anti-noise signal that destructively interferes with the noise generated by the portable air pump.
